(19) United States
(12) Patent Application Publication
(10) Pub. No.: US 2013/0130895 A1
(43) Pub. Date: May 23, 2013

(54) Superabsorbent Comprising Pyrogenic Aluminum Oxide

(71) Applicant: BASF SE, Ludwigshafen (DE)

(72) Inventors: Norbert Herfert, Altenstadt (DE); Thomas Daniel, Waldsee (DE)

(73) Assignee: BASF SE, Ludwigshafen (DE)

(21) Appl. No.: 13/682,897

(22) Filed: Nov. 21, 2012

Related U.S. Application Data
(60) Provisional application No. 61/562,476, filed on Nov. 22, 2011.

(51) Int. Cl. B01J 20/08; B01J 20/32

(52) U.S. Cl. CPC B01J 20/08; B01J 20/3231
USPC 502/402; 423/625; 502/414; 502/401

(57) ABSTRACT

Superabsorbents comprising pyrogenic aluminum oxide exhibit a low caking tendency coupled with good absorption properties and rapid water absorption.

The present invention relates to a superabsorbent comprising pyrogenic aluminum oxide, to a process for production thereof and to the use thereof, and to hygiene articles comprising it.

Superabsorbents are known. For such materials, names such as “highly swellable polymer”, “hydrogel” (often also used for the dry form), “hydrogel-forming polymer”, “water-absorbing polymer”, “absorbent gel-forming material”, “swellable resin”, “water-absorbing resin” or the like are also commonly used. These polymers are crosslinked hydrophilic polymers, more particularly polymers formed from (co)polymerized hydrophilic monomers, graft (co)polymers of one or more hydrophilic monomers on a suitable graft base, crosslinked cellulose ethers or starch ethers, crosslinked carboxymethylcellulose, partly crosslinked polyalkylene oxide or natural products swellable in aqueous liquids, for example guar derivatives, the most common being superabsorbents based on partly neutralized acrylic acid. The essential properties of superabsorbents are their abilities to absorb several times their own weight of aqueous liquids and not to release the liquid again, even under a certain pressure. The superabsorbent, which is used in the form of a dry powder, is converted to a gel when it absorbs liquid, and correspondingly to a hydrogel when it absorbs water as usual. Crosslinking is essential for synthetic superabsorbents and is an important difference from customary straightforward thickeners, since it leads to the insolubility of the polymers in water. Soluble substances would be unusable as superabsorbents. By far the most important field of use of superabsorbents is the absorption of body fluids. Superabsorbents are used, for example, in diapers for infants, incontinence products for adults or feminine hygiene products. Other fields of use are, for example, as water-retaining agents in market gardening, as water stores for protection from fire, for liquid absorption in food packaging, or quite generally for absorbing moisture.

Superabsorbents are capable of absorbing several times their own weight of water and of retaining it under a certain pressure. In general, such a superabsorbent has a centrifuge retention capacity (“CRC”, see below for test method) of at least 5 g/g, preferably at least 10 g/g and more preferably at least 15 g/g. A “superabsorbent” may also be a mixture of different individual superabsorbent substances or a mixture of components which exhibit superabsorbent properties only when they interact; it is not so much the substance composition as the superabsorbent properties that are important here.

What is important for a superabsorbent is not just its absorption capacity but also the ability to retain liquid under pressure (retention) and liquid transport in the swollen state, i.e. the permeability to liquids in the swollen gel. Swollen gel can hinder or prevent liquid transport to as yet unswollen superabsorbent (“gel blocking”). Good transport properties for liquids are possessed, for example, by hydrogels which have a high gel strength in the swollen state. Gels with only a low gel strength are deformable under an applied pressure (body pressure), block pores in the superabsorbent/cellulose fiber suction body and thus prevent further absorption of liquid. An increased gel strength is generally achieved through a higher degree of crosslinking, but this reduces the absorption capacity of the product. An elegant method of increasing the gel strength is that of increasing the degree of crosslinking at the surface of the superabsorbent particles compared to the interior of the particles. To this end, superabsorbent particles which have usually been dried in a surface postcrosslinking step and have an average crosslinking density are subjected to additional crosslinking in a thin surface layer of the particles thereof. The surface postcrosslinking increases the crosslinking density in the shell of the superabsorbent particles, which raises the absorption under compressive stress to a higher level. While the absorption capacity in the surface layer of the superabsorbent particles falls, their core, as a result of the presence of mobile polymer chains, has an improved absorption capacity compared to the shell, such that the shell structure ensures improved liquid conduction, without occurrence of gel blocking. It is likewise known that superabsorbents which are relatively highly crosslinked overall can be obtained and the degree of crosslinking in the interior of the particles can subsequently be reduced compared to an outer shell of the particles.

Processes for producing superabsorbents are also known. Superabsorbents based on acrylic acid, which are the most common on the market, are produced by free-radical polymerization of acrylic acid in the presence of a crosslinker (the “inner crosslinker”), the acrylic acid being neutralized to a certain degree before, after or partly before and partly after the polymerization, typically by adding alkali, usually an aqueous sodium hydroxide solution. The polymer gel thus obtained is comminuted (according to the polymerization reactor used, this can be done simultaneously with the polymerization) and dried. The dry powder thus obtained (the “base polymer”) is typically postcrosslinked on the surface of the particles, by reacting it with further crosslinkers, for instance organic crosslinkers or polyvalent cations, for example aluminum (usually used in the form of aluminum sulfate) or both, in order to obtain a more highly crosslinked surface layer compared to the particle interior.

A problem which often occurs in superabsorbents is the caking tendency that these substances, which are moisture-absorbing by nature, exhibit especially in moist air. Especially in the case of storage or processing of superabsorbents in tropical or subtropical countries, this is a common problem which considerably complicates the storage and processing of superabsorbents. Storage and processing can take place in rooms supplied with dried air, but this is energy-intensive and costly.

Fredric L. Buchholz and Andrew T. Graham (publishers) give, in: “Modern Superabsorbent Polymer Technology”, J. Wiley & Sons, New York, U.S.A./Wiley-VCH, Weinheim, Germany, 1997, ISBN 0-471-19411-5, a comprehensive review of superabsorbents, the properties thereof and processes for producing superabsorbents. In chapter 3.2.8.2. “Additives for Improved Handling”, it is taught therein that the caking tendency can be counteracted by additives; customary additives specified are oils, as also used in the case of hygroscopic fertilizers, polymeric soaps as drying aids for acrylamide copolymers, and particulate silica in combination with polyols or polyalkylene glycols as a flow assistant for poly(acrylamide) polymers and copolymers. Additionally mentioned are quaternary surfactants, alone or in combination with further additives, in order to reduce dust formation, which is a disadvantage of the addition of silica. All these additives can be added in a multitude of types of mixers customary on the market.

Addition of silica or other inorganic powders to reduce the caking tendency (i.e. as “anticaking agents”), as well as increased dust formation, often has the disadvantage that some properties of the superabsorbent are worsened as a result. More particularly, there is a fall in conveyability in screw conveyors and, in the case of measurement of properties which require the swelling of the superabsorbent under pressure, superabsorbents treated in such a way sometimes give poorer results, probably because the superabsorbent particles covered with inorganic particles, when being conveyed or swelling under pressure, cannot slide past one another as well. However, this in turn increases the permeability for liquid in the swollen gel, because open pores and passages are preserved, which can also be a desirable effect. Dust formation, poor conveyability and worsened swelling under pressure can be counteracted again by addition of antidusting agents (also referred to as “dust binders”). The polyols and polyalkylene glycols usually used as antidusting agents not only bind dust, but also act as lubricants between the superabsorbent particles. When the caking tendency of superabsorbents common on the market at the storage and processing site is a problem, the most common solution is to add silica powder, alone or in combination with antidusting agents such as polyols or polyalkylene glycols.

WO 2004/069 915 A2 teaches a superabsorbent which comprises 0.01 to 5% of a water-insoluble inorganic powder such as silica. WO 2008/055 935 A2 discloses a superabsorbent which comprises optimized amounts of inorganic powder and antidusting agents such as polyols, for example 1,2-propylene glycol, 1,3-propanediol, 1,2-, 1,3- or 1,4-butanediol or glycerol, or polyglycols such as polyethylene glycol, polypropylene glycol or polybutylene glycol, the latter typically having a molar mass of up to 5000 g/mol. JP 63/039 934 teaches the addition of a mixture of water-insoluble inorganic powder such as silica and organic compounds such as polyethylene glycol or ethers thereof.

It is likewise known that superabsorbents can be admixed with particles such as microcrystalline cellulose or inorganic particles such as silica or clays, in order to lower the water absorption rate, which improves the absorption of water from liquids comprising cells, such as blood, as taught in WO 00/62 825 A2.

WO 2004/018 005 A1 and WO 2004/018 006 A1 describe superabsorbents with added clay. WO 2005/097 881 A1 and WO 02/060 983 A2 disclose superabsorbents comprising water-insoluble phosphates and WO 2006/058 683 A2 relates to superabsorbents comprising insoluble metal sulfates.

WO 94/22 940 A1 teaches the dedusting of superabsorbents with aliphatic polyols having a mean molecular weight of more than 200 g/mol or polyalkylene glycols of mean molecular weight between 400 and 6000 g/mol. Polyether polyols are also mentioned. The superabsorbent thus dedusted can additionally be admixed with flow assistants (as they are called therein) such as silica.

U.S. Pat. No. 7,795,345 and U.S. Pat. No. 3,932,322 disclose the addition of fumed silicas or pyrogenic aluminum oxides to superabsorbents.

It is a continuing objective to find novel or improved superabsorbents with a reduced caking tendency. There should be only insignificant, if any, impairment of the service properties of the superabsorbent, especially its absorption capacity for liquid, including under pressure, and its ability to conduct liquid, but also its conveyability.

The objective is achieved by a superabsorbent comprising pyrogenic aluminum oxide. In addition, a process for producing this superabsorbent has been found, as have uses of this superabsorbent and hygiene articles which comprise this superabsorbent.

The inventive superabsorbent exhibits a low caking tendency, without any relevant impairment in the service properties thereof.

The inventive superabsorbent comprises pyrogenic aluminum oxide. Pyrogenic aluminum oxide is aluminum oxide which has been produced by means of a pyrogenic process, i.e. not by precipitation like most of the aluminum oxides. Pyrogenic processes are processes in which an oxide is produced by flame oxidation or flame hydrolysis of a suitable starting compound in a flame, in the case of flame hydrolysis typically a hydrogen/oxygen gas flame. Pyrogenic aluminum oxide is typically obtained by flame oxidation of a vaporizable aluminum compound or by flame hydrolysis of a vaporizable aluminum compound in a hydrogen/oxygen gas flame. The vaporizable aluminum compound used is typically aluminum chloride; in the hydrogen/oxygen gas flame, this forms pyrogenic aluminum oxide and hydrogen chloride. Processes for production of pyrogenic aluminum oxide are known, and pyrogenic aluminum oxide is a standard commercial product available, for example, under the AEROXIDE® Alu brand from Evonik Industries AG, Inorganic Materials, Rodenbacher Chaussee 4, 63457 Hanau-Wolfgang, Germany. Compared to the aluminum oxide obtained by precipitation, it is usually purer and has finer particles and higher surface area.

Pyrogenic aluminum oxide typically has a BET surface area of at least 20 m²/g, preferably at least 30 m²/g and more preferably at least 50 m²/g, and typically of at most 200 m²/g, preferably at most 180 m²/g and more preferably at most 150 m²/g. (The BET surface area is the specific surface area of a solid determined by absorption of gases by the method reported for the first time by Stephen Brunauer, Paul Hugh Emmett and Edward Teller in J. Am. Chem. Soc. 60 (1938) 309. It is found according to DIN ISO 9277: 2003-05 (“Determination of the specific surface area of solids by gas adsorption using the BET method”). A simplified method which generally gives comparable results, within the accuracy of measurement, is specified in DIN 66132: 1975-07 (“Adsorption of nitrogen; single-point differential method according to Haul and Dümbgen”). In the event of deviations, the former standard applies in the context of this invention. The BET method is a well-known and routinely used method in the specialist field of porous solids, including catalysts.)

In general, the pyrogenic aluminum oxide is added to the superabsorbent in an amount of at least 0.005% by weight, preferably of at least 0.03% by weight and more preferably of at least 0.05% by weight, and generally of at most 6.0% by weight, preferably at most 1.0% by weight and more preferably at most 0.5% by weight, based in each case on the total weight of the superabsorbent comprising pyrogenic aluminum oxide.

The superabsorbent is—apart from the addition of pyrogenic aluminum oxide—produced in a customary manner. A preferred process for preparing the acrylate superabsorbent dominant on the market is the aqueous solution polymerization of a monomer mixture comprising

a) at least one ethylenically unsaturated monomer which bears acid groups and is optionally present at least partly in salt form,

b) at least one crosslinker,

c) at least one initiator,

d) optionally one or more ethylenically unsaturated monomers copolymerizable with the monomers mentioned under a), and

optionally one or more water-soluble polymers.

The monomers a) are preferably water-soluble, i.e. the solubility in water at 23° C. is typically at least 1 g/100 g of water, preferably at least 5 g/100 g of water, more preferably at least 25 g/100 g of water and most preferably at least 35 g/100 g of water.

Suitable monomers a) are, for example, ethylenically unsaturated carboxylic acids or salts thereof, such as acrylic acid, methacrylic acid, maleic acid, maleic anhydride and itaconic acid or salts thereof. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 and comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %, most preferably at least 95 mol %.

The monomer solution comprises preferably at most 250 ppm by weight, preferably at most 130 ppm by weight, more preferably at most 70 ppm by weight and preferably at least 10 ppm by weight, more preferably at least 30 ppm by weight, especially around 50 ppm by weight, of hydroquinone monoether, based in each case on the unneutralized monomer a); neutralized monomer a), i.e. a salt of the monomer a), is considered for arithmetic purposes to be unneutralized monomer. For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 530 438 A1, di- and triacrylates, as described in EP 547 847 A1, EP 559 476 A1, EP 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 2002/32962 A2.

Preferred crosslinkers b) are pentaerythrityl triallyl ether, tetraallyloxyethane, methylenebismethacrylamide, 10 to 20-tuply ethoxylated trimethylolpropane triacrylate, 10 to 20-tuply ethoxylated trimethylolethane triacrylate, more preferably 15-tuply ethoxylated trimethylolpropane triacrylate, polyethylene glycol diacrylates having 4 to 30 ethylene oxide units in the polyethylene glycol chain, trimethylolpropane triacrylate, di- and triacrylates of 3 to 30-tuply ethoxylated glycerol, more preferably di- and triacrylates of 10-20-tuply ethoxylated glycerol, and triallylamine. The polyols incompletely esterified with acrylic acid may also be present here as Michael adducts with one another, as a result of which it is also possible for tetraacrylates, pentaacrylates or even higher acrylates to be present.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably 0.05 to 1.5% by weight, more preferably 0.1 to 1% by weight and most preferably 0.3 to 0.6% by weight, based in each case on monomer a). With rising crosslinker content, the centrifuge retention capacity (CRC) falls and the absorption against a pressure of 0.7 psi rises (“AAP (0.7 psi)”; see below for test method).

The initiators c) used may be all compounds which generate free radicals under the polymerization conditions, for example thermal initiators, redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is, however, preferably a mixture of the sodium salt of 2-hydroxy-2-sulfinatoacetic acid, the disodium salt of 2-hydroxy-2-sulfonatoacetic acid and sodium bisulfite (in the form of Brüggolit® FF6M or Brüggolit® FF7, or alternatively BRUGGOLITE® FF6M or BRUGGOLITE® FF7, available from L. Brüggemann KG, Salzstrasse 131, 74076 Heilbronn, Germany, www.brueggemann.com).

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate, maleic acid and maleic anhydride.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight and most preferably from 50 to 65% by weight. It is also possible to use monomer suspensions, i.e. oversaturated monomer solutions. With rising water content, the energy requirement in the subsequent drying rises, and, with falling water content, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

The monomer mixture may comprise further components. Examples of further components used in monomer mixtures of this kind are, for instance, chelating agents, in order to keep metal ions in solution. This is known; all known chelating agents can be used. The most commonly used chelating agents are aminocarboxy acids and salts thereof, for instance nitrilotriacetic acid (“NTA”), ethylenediaminetetraacetic acid (“EDTA”) and compounds of analogous structure, but also polymers such as the sodium salt of N-carboxymethylated polyamine (Trilon® P from BASF SE, Ludwigshafen, Germany); amides of polybasic carboxylic acids, for instance citramides and malonamides; acylated amino acids; hydroxycarboxylic acids and salts thereof, such as lactic acid, glycolic acid, malic acid, glyceric acid, tartaric acid, citric acid, isocitric acid and salts thereof, especially sodium salts; diketones and derivatives thereof, tropolone and derivatives thereof; esters of phosphoric acid or of phosphorous acid and salts thereof; chelate-forming organic compounds of phosphonic acid; inorganic phosphates such as sodium tripolyphosphate; organic heterocyclic compounds such as phenanthroline, 2,2′-bipyridine, terpyridine and derivatives thereof.

Further examples of further components used in such monomer mixtures are, for instance, reducing agents (also “antioxidants” or “stabilizers”), which reduce any yellowing tendency of the finished product. Here too, it is possible to use any additive known therefor. Examples of such reducing agents are phenols, phosphonic acid (HP(O)(OH)₂), phosphorous acid (H₃PO₃) and the salts and esters of these acids. Among the phenols, preference is given to the sterically hindered phenols. Sterically hindered phenols are understood to mean phenols which bear a singly or doubly branched substituent, preferably a doubly branched substituent, at least in the 2 position and optionally also in the 6 position on the phenyl ring. Branched substituents are understood to mean substituents which bear, on the atom bonded to the phenyl ring of the phenol, apart from the carbon atom of the phenyl ring to which they are bonded, at least two radicals other than hydrogen. However, sterically hindered phenols are also those which bear a sterically demanding unbranched substituent at least in the 2 position and optionally also in the 6 position. This is understood to mean substituents which comprise at least 6, preferably at least 8 and more preferably at least 12 atoms other than hydrogen, but, on the atom bonded to the phenyl ring of the phenol, apart from the carbon atom of the phenyl ring to which they are bonded, bear only one radical other than hydrogen. The simplest examples of singly branched substituents are secondary alkyl radicals such as 2-propyl, 2-butyl, 2-pentyl, 3-pentyl, ethylhexyl, or cycloalkyl radicals such as cyclobutyl, cyclopentyl, cyclohexyl, or aromatic radicals such as phenyl. The simplest examples of doubly branched substituents are tertiary alkyl radicals such as tert-butyl, tert-pentyl or norbornyl. The simplest examples of unbranched radicals are hexyl, heptyl, octyl, nonyl, decyl, undecyl and dodecyl, but also neopentyl, neohexyl or dodecylthiomethyl. All these radicals may, however, also themselves be substituted or comprise atoms other than carbon and hydrogen. The phenyl ring of the phenol may, in addition to the substituent in the 2 position and optionally in the 6 position, also optionally bear further substituents. Examples of preferred sterically hindered phenols are 2-tert-butylphenol, 2,6-di-tert-butylphenol, 2,6-di-tert-butyl-4-methylphenol (also referred to as 2,6-di-tert-butyl-para-cresol or 3,5-di-tert-butyl-4-hydroxytoluene), 3,5-di-tert-butyl-4-hydroxyphenylacetic acid, 3,5-di-tert-butyl-4-hydroxyphenylpropionic acid and the esters of these acids with alcohols and polyols, for example the mono- or polyesters thereof with glycol, glycerol, 1,2- or 1,3-propanediol, trimethylolpropane or pentaerythritol, for instance pentaerythrityl tetrakis(3-(3,5-di-tert-butyl-4-hydroxyphenyl)propionate) or octadecyl (3,5-di-tert-butyl-4-hydroxyphenyl)propionate), 4,4-thiobis(6-tert-butyl-meta-cresol), 4,6-bis(dodecylthiomethyl)-ortho-cresol, 3,3′,3″,5,5′,5″-hexa-tert-butyl-α,α′,α″-(mesitylene-2,4,6-triyl)tri-para-cresol (alternative name for 2,4,6-tri[(4-hydroxy-3,5-di-tert-butylphenyl)methyl]mesitylene, CAS No. 1709-70-2, obtainable from BASF Schweiz AG, Basle, Switzerland, under the Irganox® 1330 brand), N,N-hexane-1,3-diylbis (3-(3,5-di-tert-butyl-4-hydroxyphenylpropionamide)), 2,2′-ethylidenebis[4,6-bis(1,1-dimethylethyl) phenol] and ethylenebis(oxyethylene) bis-3-(5-tert-butyl-4-hydroxy-m-tolyl)propionate) (CAS No. 36443-68-2, obtainable from BASF Schweiz AG, Basle, Switzerland, under the Irganox® 245 brand). Further reducing agents are salts and esters of phosphonic acid (HP(O)(OH)₂) and phosphorous acid (H₃PO₃), and also phosphonic acid itself. Phosphonic acid is tautomeric with phosphorous acid; the latter does not exist as the free acid. True derivatives of phosphorous acid are solely the triesters thereof, which are typically referred to as phosphites. The derivatives of tautomeric phosphonic acid are typically referred to as phosphonates. For example, all primary and secondary phosphonates of the alkali metals, including those of ammonium, and of the alkaline earth metals, are suitable. Suitable examples are also aqueous solutions of phosphonic acid which comprise primary and/or secondary phosphonate ions and at least one cation selected from sodium, potassium, calcium, strontium. Examples of suitable phosphites or phosphonates are calcium bis[monoethyl(3,5-di-tert-butyl-4-hydroxybenzyl)phosphonate], tris(2,4-di-tert-butylphenyl) phosphite, 3,9-bis(octadecyloxy)-2,4,8,10-tetraoxa-3,9-diphosphaspiro[5.5]undecane and bis(2,4-di-tert-butylphenyl)pentaerythrityl diphosphite. Stabilizers may at the same time be phosphonates or phosphites and sterically hindered phenols.

Suitable polymerization reactors are, for example, kneading reactors or belt reactors. In the kneader, the polymer gel formed in the polymerization of an aqueous monomer solution or suspension is comminuted continuously by, for example, contrarotatory stirrer shafts, as described in WO 2001/38402 A1. Polymerization on the belt is described, for example, in DE 38 25 366 A1 and U.S. Pat. No. 6,241,928. Polymerization in a belt reactor forms a polymer gel which has to be comminuted in a further process step, for example in a meat grinder, extruder or kneader. It is also possible to produce spherical superabsorbent particles by suspension, spray or droplet polymerization processes. The use of urea phosphate, which is particularly preferred in accordance with the invention, is particularly advantageous especially in the case of polymerization processes such as, for example, a kneading reactor or a droplet polymerization with relatively short polymerization time.

The acid groups of the resulting polymer gels have typically been partially neutralized. Neutralization is preferably carried out at the monomer stage; in other words, salts of the monomers bearing acid groups or, to be precise, a mixture of monomers bearing acid groups and salts of the monomers bearing acid groups (“partly neutralized acid”) are used as component a) in the polymerization. This is typically accomplished by mixing the neutralizing agent as an aqueous solution or preferably also as a solid into the monomer mixture intended for polymerization or preferably into the monomer bearing acid groups or a solution thereof. The degree of neutralization is preferably from 25 to 95 mol %, more preferably from 50 to 80 mol % and most preferably from 65 to 72 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metal cations are sodium and potassium, but very particular preference is given to sodium hydroxide, sodium carbonate or sodium hydrogencarbonate and also mixtures thereof.

However, it is also possible to carry out neutralization after the polymerization, at the stage of the polymer gel formed in the polymerization. It is also possible to neutralize up to 40 mol %, preferably 10 to 30 mol % and more preferably 15 to 25 mol % of the acid groups before the polymerization by adding a portion of the neutralizing agent directly to the monomer solution and setting the desired final degree of neutralization only after the polymerization, at the polymer gel stage. When the polymer gel is neutralized at least partly after the polymerization, the polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

However, preference is given to performing the neutralization at the monomer stage. In other words: in a very particularly preferred embodiment, the monomer a) used is a mixture of 25 to 95 mol %, more preferably from 50 to 80 mol % and most preferably from 65 to 72 mol % of salt of the monomer bearing acid groups, and the remainder to 100 mol % of monomer bearing acid groups. This mixture is, for example, a mixture of sodium acrylate and acrylic acid or a mixture of potassium acrylate and acrylic acid.

In a preferred embodiment, the neutralizing agent used for the neutralization is one whose iron content is generally below 10 ppm by weight, preferably below 2 ppm by weight and more preferably below 1 ppm by weight. Likewise desired is a low content of chloride and anions of oxygen acids of chlorine. A suitable neutralizing agent is, for example, the 50% by weight sodium hydroxide solution or potassium hydroxide solution which is typically traded as “membrane grade”; even more pure, but also more expensive, is the 50% by weight sodium hydroxide solution or potassium hydroxide solution typically traded as “amalgam grade” or “mercury process”.

The polymer gel obtained from the aqueous solution polymerization and optional subsequent neutralization is then preferably dried with a belt drier until the residual moisture content is preferably 0.5 to 15% by weight, more preferably 1 to 10% by weight and most preferably from 2 to 8% by weight (see below for test method for the residual moisture or water content). In the case of too high a residual moisture content, the dried polymer gel has too low a glass transition temperature Tg and can be processed further only with difficulty. In the case of too low a residual moisture content, the dried polymer gel is too brittle and, in the subsequent comminution steps, undesirably large amounts of polymer particles with an excessively low particle size are obtained (“fines”). The solids content of the gel before drying is generally from 25 to 90% by weight, preferably from 30 to 80% by weight, more preferably from 35 to 70% by weight and most preferably from 40 to 60% by weight. Optionally, however, it is also possible to dry using a fluidized bed drier or a heatable mixer with a mechanical mixing unit, for example a paddle drier or a similar drier with mixing tools of different design. Optionally, the drier can be operated under nitrogen or another nonoxidizing inert gas or at least under reduced partial oxygen pressure in order to prevent oxidative yellowing processes. In general, however, even sufficient venting and removal of water vapor leads to an acceptable product. In general, a minimum drying time is advantageous with regard to color and product quality. In the case of the standard belt driers, in a customary mode of operation, a temperature of the gas used for drying of at least 50° C., preferably at least 80° C. and more preferably at least 100° C., and generally of at most 250° C., preferably at most 200° C. and more preferably of at most 180° C. is established for this purpose. Standard belt driers often have two or more chambers; the temperature in these chambers may be different. For each drier type, the operating conditions overall should be chosen in a known manner such that the desired drying outcome is achieved.

During the drying, the residual monomer content in the polymer particles is also reduced, and last residues of the initiator are destroyed.

Thereafter, the dried polymer gel is ground and classified, and the apparatus used for grinding may typically be single or multistage roll mills, preferably two- or three-stage roll mills, pin mills, hammer mills or vibratory mills. Oversize gel lumps which often still have not dried on the inside are elastomeric, lead to problems in the grinding and are preferably removed before the grinding, which can be done in a simple manner by wind sifting or by means of a sieve (“guard sieve” for the mill). In view of the mill used, the mesh size of the sieve should be selected such that a minimum level of disruption resulting from oversize, elastomeric particles occurs.

Excessively large, insufficiently finely ground superabsorbent particles are perceptible as coarse particles in their predominant use, in hygiene products such as diapers; they also lower the mean initial swell rate of the superabsorbent. Both are undesired. Advantageously, coarse-grain polymer particles are therefore removed from the product. This is done by conventional classification processes, for example wind sifting, or by sieving through a sieve with a mesh size of at most 1000 μm, preferably at most 900 μm, more preferably at most 850 μm and most preferably at most 800 μm. For example, sieves of mesh size 700 μm, 650 μm or 600 μm are used. The coarse polymer particles (“oversize”) removed may, for cost optimization, be sent back to the grinding and sieving cycle or be processed further separately.

Polymer particles of too small a particle size lower the permeability for liquids in the swollen gel. Advantageously, this classification therefore also removes fine polymer particles. This can, if sieving is effected, conveniently be achieved using a sieve of mesh size at most 300 μm, preferably at most 200 μm, more preferably at most 150 μm and most preferably at most 100 μm. The fine polymer particles (“undersize” or “fines”) removed can, for cost optimization, be sent back as desired to the monomer stream, to the polymerizing gel, or to the fully polymerized gel before the drying of the gel.

The mean particle size of the polymer particles removed as the product fraction is generally at least 200 μm, preferably at least 250 μm and more preferably at least 300 μm, and generally at most 600 μm and more preferably at most 500 μm. The proportion of particles with a particle size of at least 150 μm is generally at least 90% by weight, more preferably at least 95% by weight and most preferably at least 98% by weight. The proportion of particles with a particle size of at most 850 μm is generally at least 90% by weight, more preferably at least 95% by weight and most preferably at least 98% by weight.

The polymer thus prepared has superabsorbent properties and is covered by the term “superabsorbent”. The CRC thereof is typically comparatively high; the AAP (0.7 psi) or permeability thereof for liquids in the swollen gel, in contrast, is comparatively low. A surface nonpostcrosslinked superabsorbent of this type is often referred to as “base polymer” to distinguish it from a surface postcrosslinked superabsorbent produced therefrom.

To further improve the properties, especially increase the AAP (0.7 psi) and permeability (which lowers the CRC value), the superabsorbent particles can be surface postcrosslinked. Suitable postcrosslinkers are compounds which comprise groups which can form bonds with at least two functional groups of the superabsorbent particles. In the case of the acrylic acid/sodium acrylate-based superabsorbents prevalent on the market, suitable surface postcrosslinkers are compounds which comprise groups which can form bonds with at least two carboxylate groups. Preferred postcrosslinkers are amide acetals or carbamates of the general formula (I)

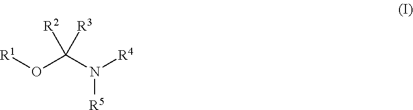

in which

R¹ is C₁-C₁₂-alkyl, C₂-C₁₂-hydroxyalkyl, C₂-C₁₂-alkenyl or C₆-C₁₂-aryl,

R² is X or OR⁶,

R³ is hydrogen, C₁-C₁₂-alkyl, C₂-C₁₂-hydroxyalkyl, C₂-C₁₂-alkenyl or C₆-C₁₂-aryl, or X,

R⁴ is C₁-C₁₂-alkyl, C₂-C₁₂-hydroxyalkyl, C₂-C₁₂-alkenyl or C₆-C₁₂-aryl,

R⁵ is hydrogen, C₁-C₁₂-alkyl, C₂-C₁₂-hydroxyalkyl, C₂-C₁₂-alkenyl, C₁-C₁₂-acyl or C₆-C₁₂-aryl,

R⁶ is C₁-C₁₂-alkyl, C₂-C₁₂-hydroxyalkyl, C₂-C₁₂-alkenyl or C₆-C₁₂-aryl and

X is a carbonyl oxygen common to the R² and R³ radicals,

where R¹ and R⁴ and/or R⁵ and R⁶ may be a bridged C₂-C₆-alkanediyl and where the abovementioned R¹ to R⁶ radicals may also have a total of from one to two free valences and may be joined to at least one suitable base structure by these free valences,

or polyhydric alcohols, the polyhydric alcohol preferably having a molecular weight of less than 100 g/mol, preferably of less than 90 g/mol, more preferably of less than 80 g/mol, most preferably of less than 70 g/mol, per hydroxyl group, and no vicinal, geminal, secondary or tertiary hydroxyl groups, and polyhydric alcohols are either diols of the general formula (IIa)

HO—R⁷—OH (IIa)

in which R⁷ is either an unbranched alkylene radical of the formula -(CH₂)ₙ- where n is an integer from 3 to 20, preferably from 3 to 12, and both hydroxyl groups are terminal, or R⁷ is an unbranched, branched or cyclic alkylene radical, or polyols of the general formula (IIb)

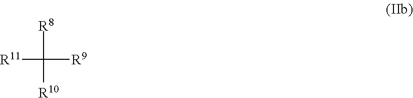

in which the R⁸, R⁹, R¹⁰, R¹¹ radicals are each independently hydrogen, hydroxyl, hydroxymethyl, hydroxyethyloxymethyl, 1-hydroxyprop-2-yloxymethyl, 2-hydroxypropyloxymethyl, methyl, ethyl, n-propyl, isopropyl, n-butyl, n-pentyl, n-hexyl, 1,2-dihydroxyethyl, 2-hydroxyethyl, 3-hydroxypropyl or 4-hydroxybutyl, and a total of 2, 3 or 4, preferably 2 or 3, hydroxyl groups are present, and not more than one of the R⁸, R⁹, R¹⁰ and R¹¹ radicals is hydroxyl,

or cyclic carbonates of the general formula (III)

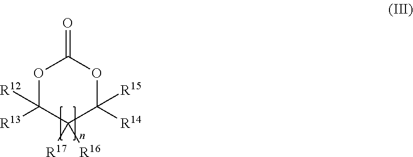

in which R12, R¹³, R¹⁴, R¹⁵, R¹⁶ and R¹⁷ are each independently hydrogen, methyl, ethyl, n-propyl, isopropyl, n-butyl, sec-butyl or isobutyl, and n is either 0 or 1,

or bisoxazolines of the general formula (IV)

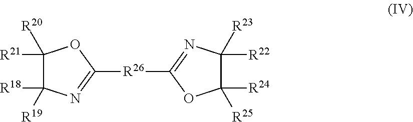

in which R¹⁸, R¹⁹, R²⁰, R²¹, R²², R²³, R²⁴ and R²⁵ are each independently hydrogen, methyl, ethyl, n-propyl, isopropyl, n-butyl, sec-butyl or isobutyl, and R²⁶ is a single bond, a linear, branched or cyclic C₂-C₁₂-alkylene radical, or a polyalkoxydiyl radical which is formed from one to ten ethylene oxide and/or propylene oxide units, as possessed, for example, by polyglycoldicarboxylic acids.

Preferred postcrosslinkers of the general formula (I) are 2-oxazolidones such as 2-oxazolidone and N-(2-hydroxyethyl)-2-oxazolidone, N-methyl-2-oxazolidone, N-acyl-2-oxazolidones such as N-acetyl-2-oxazolidone, 2-oxotetrahydro-1,3-oxazine, bicyclic amide acetals such as 5-methyl-1-aza-4,6-dioxabicyclo[3.3.0]octane, 1-aza-4,6-dioxabicyclo[3.3.0]octane and 5-isopropyl-1-aza-4,6-dioxabicyclo[3.3.0]octane, bis-2-oxazolidones and poly-2-oxazolidones.

Particularly preferred postcrosslinkers of the general formula (I) are 2-oxazolidone, N-methyl-2-oxazolidone, N-(2-hydroxyethyl)-2-oxazolidone and N-hydroxypropyl-2-oxazolidone.

Preferred postcrosslinkers of the general formula (IIa) are 1,3-propanediol, 1,5-pentanediol, 1,6-hexanediol and 1,7-heptanediol. Further examples of postcrosslinkers of the formula (IIa) are 1,3-butanediol, 1,8-octanediol, 1,9-nonanediol and 1,10-decanediol.

The diols are preferably water-soluble, the diols of the general formula (IIa) being water-soluble at 23° C. to an extent of at least 30% by weight, preferably to an extent of at least 40% by weight, more preferably to an extent of at least 50% by weight, most preferably at least to an extent of 60% by weight, for example 1,3-propanediol and 1,7-heptanediol. Even more preferred are those postcrosslinkers which are liquid at 25° C.

Preferred postcrosslinkers of the general formula (IIb) are butane-1,2,3-triol, butane-1,2,4-triol, glycerol, trimethylolpropane, trimethylolethane, pentaerythritol, 1- to 3-tuply (per molecule) ethoxylated glycerol, trimethylolethane or trimethylolpropane and 1- to 3-tuply (per molecule) propoxylated glycerol, trimethylolethane or trimethylolpropane. Additionally preferred are 2-tuply ethoxylated or propoxylated neopentyl glycol. Particular preference is given to 2-tuply and 3-tuply ethoxylated glycerol, neopentyl glycol, 2-methyl-1,3-propanediol and trimethylolpropane.

Preferred polyhydric alcohols (IIa) and (IIb) have, at 23° C., a viscosity of less than 3000 mPas, preferably less than 1500 mPas, more preferably less than 1000 mPas, especially preferably less than 500 mPas and very especially preferably less than 300 mPas.

Particularly preferred postcrosslinkers of the general formula (III) are ethylene carbonate and propylene carbonate.

A particularly preferred postcrosslinker of the general formula (IV) is 2,2′-bis(2-oxazoline).

The preferred postcrosslinkers minimize side reactions and subsequent reactions which lead to volatile and hence malodorous compounds. The superabsorbents produced with the preferred postcrosslinkers are therefore odor-neutral even in the moistened state.

It is possible to use an individual postcrosslinker from the above selection or any mixtures of different postcrosslinkers.

The postcrosslinker is generally used in an amount of at least 0.001% by weight, preferably of at least 0.02% by weight, more preferably of at least 0.05% by weight, and generally at most 2% by weight, preferably at most 1% by weight, more preferably at most 0.3% by weight, for example at most 0.15% by weight or at most 0.095% by weight, based in each case on the mass of the base polymer.

The postcrosslinking is typically performed in such a way that a solution of the postcrosslinker is sprayed onto the dried base polymer particles. After the spraying, the polymer particles coated with postcrosslinker are dried thermally, and the postcrosslinking reaction can take place either before or during the drying. If surface postcrosslinkers with polymerizable groups are used, the surface postcrosslinking can also be effected by means of free-radically induced polymerization of such groups by means of common free-radical formers or else by means of high-energy radiation, for example UV light. This can be done in parallel with or instead of the use of postcrosslinkers which form covalent or ionic bonds to functional groups at the surface of the base polymer particles.

The spray application of the postcrosslinker solution is preferably carried out in mixers with moving mixing tools, such as screw mixers, disk mixers, paddle mixers or shovel mixers, or mixers with other mixing tools. Particular preference is given, however, to vertical mixers. However, it is also possible to spray on the postcrosslinker solution in a fluidized bed. Suitable mixers are obtainable, for example, as Pflugschar® plowshare mixers from Gebr. Lödige Maschinenbau GmbH, Elsener-Strasse 7-9, 33102 Paderborn, Germany, or as Schugi® Flexomix® mixers, Vrieco-Nauta® mixers or Turbulizer® mixers from Hosokawa Micron BV, Gildenstraat 26, 7000 AB Doetinchem, the Netherlands.

The spray nozzles usable are not subject to any restriction. Suitable nozzles and atomization systems are described, for example, in the following references: Zerstäuben von Fliissigkeiten [Atomization of Liquids], Expert-Verlag, vol. 660, Reihe Kontakt & Studium, Thomas Richter (2004) and in Zerstäubungstechnik [Atomization Technology], Springer-Verlag, VDI-Reihe, Günter Wozniak (2002). It is possible to use mono- and polydisperse spray systems. Among the polydisperse systems, one-substance pressurized nozzles (jet- or lamella-forming), rotary atomizers, two-substance atomizers, ultrasound atomizers and impingement nozzles are suitable. In the case of the two-substance atomizers, the liquid phase can be mixed with the gas phase either internally or externally. The spray profile of the nozzles is uncritical and may assume any desired form, for example a round jet, flat jet, wide angle round beam or circular ring spray profile. It is advantageous to use a nonoxidizing gas if two-substance atomizers are used, particular preference being given to nitrogen, argon or carbon dioxide. Such nozzles can be supplied with the liquid to be sprayed under pressure. The atomization of the liquid to be sprayed can be effected by expanding it in the nozzle bore on attainment of a particular minimum velocity. In addition, it is also possible to use one-substance nozzles for the inventive purpose, for example slit nozzles or swirl chambers (full-cone nozzles) (for example from Diisen-Schlick GmbH, Germany, or from Spraying Systems Deutschland GmbH, Germany). Such nozzles are also described in EP 0 534 228 A1 and EP 1 191 051 A2.

The postcrosslinkers are typically used in the form of an aqueous solution. When exclusively water is used as the solvent, a surfactant or deagglomeration assistant is advantageously added to the postcrosslinker solution or actually to the base polymer. This improves the wetting behavior and reduces the tendency to form lumps.

All anionic, cationic, nonionic and amphoteric surfactants are suitable as deagglomeration assistants, but preference is given to nonionic and amphoteric surfactants for skin compatibility reasons. The surfactant may also comprise nitrogen. For example, sorbitan monoesters, such as sorbitan monococoate and sorbitan monolaurate, or ethoxylated variants thereof, for example Polysorbat 20®, are added. Further suitable deagglomeration assistants are the ethoxylated and alkoxylated derivatives of 2-propylheptanol, which are sold under the Lutensol XL® and Lutensol XP® brands (BASF SE, Carl-Bosch-Strasse 38, 67056 Ludwigshafen, Germany).

The deagglomeration assistant can be metered in separately or added to the postcrosslinker solution. Preference is given to simply adding the deagglomeration assistant to the postcrosslinker solution.

The amount of the deagglomeration assistant used, based on base polymer, is, for example, from 0 to 0.1% by weight, preferably from 0 to 0.01% by weight, more preferably from 0 to 0.002% by weight. The deagglomeration assistant is preferably metered in such that the surface tension of an aqueous extract of the swollen base polymer and/or of the swollen postcrosslinked superabsorbent at 23° C. is at least 0.060 N/m, preferably at least 0.062 N/m, more preferably at least 0.065 N/m, and advantageously at most 0.072 N/m.

The aqueous postcrosslinker solution may, as well as the at least one postcrosslinker, also comprise a cosolvent. The penetration depth of the postcrosslinker into the polymer particles can be adjusted via the content of nonaqueous solvent and total amount of solvent. Industrially highly suitable cosolvents are C1-C6-alcohols such as methanol, ethanol, n-propanol, isopropanol, n-butanol, sec-butanol, tert-butanol or 2-methyl-1-propanol, C2-05-diols such as ethylene glycol, 1,2-propylene glycol or 1,4-butanediol, ketones such as acetone, or carboxylic esters such as ethyl acetate. A disadvantage of many of these cosolvents is that they have typical intrinsic odors.

The cosolvent itself is ideally not a postcrosslinker under the reaction conditions. However, it may arise in the boundary case and depending on the residence time and temperature that the cosolvent contributes partly to crosslinking. This is the case especially when the postcrosslinker is relatively slow to react and can therefore also constitute its own cosolvent, as is the case, for example, when cyclic carbonates of the general formula (III), diols of the general formula (IIa) or polyols of the general formula (IIb) are used. Such postcrosslinkers can also be used in the function as a cosolvent in a mixture with more reactive postcrosslinkers, since the actual postcrosslinking reaction can then be performed at lower temperatures and/or with shorter residence times than in the absence of the more reactive crosslinker. Since the cosolvent is used in relatively large amounts and some also remains in the product, it must not be toxic.

In the process according to the invention, the diols of the general formula (IIa), the polyols of the general formula (IIb) and the cyclic carbonates of the general formula (III) are also suitable as cosolvents. They fulfill this function in the presence of a reactive postcrosslinker of the general formula (I) and/or (IV) and/or of a di- or triglycidyl compound. Preferred cosolvents in the process according to the invention are, however, especially the diols of the general formula (IIa), especially when a reaction of the hydroxyl groups is hindered sterically by neighboring groups. Although such diols are also suitable in principle as postcrosslinkers, this requires significantly higher reaction temperatures or optionally higher use amounts than for sterically unhindered diols.

Particularly preferred combinations of low-reactivity postcrosslinker as a cosolvent and reactive postcrosslinker are combinations of preferred polyhydric alcohols, diols of the general formula (IIa) and polyols of the general formula (IIb), with amide acetals or carbamates of the general formula (I).

Suitable combinations are, for example, 2-oxazolidone/1,2-propanediol and N-(2-hydroxyethyl)-2-oxazolidone/1,2-propanediol, and also ethylene glycol diglycidyl ether/1,2-propanediol.

Very particularly preferred combinations are 2-oxazolidone/1,3-propanediol and N-(2-hydroxyethyl)-2-oxazolidone/1,3-propanediol.

Further preferred combinations are those with ethylene glycol diglycidyl ether or glyceryl di- or triglycidyl ether with the following solvents, cosolvents or cocrosslinkers: isopropanol, 1,3-propanediol, 1,2-propylene glycol or mixtures thereof.

Further preferred combinations are those with 2-oxazolidone or (2-hydroxyethyl)-2-oxazolidone in the following solvents, cosolvents or cocrosslinkers: isopropanol, 1,3-propanediol, 1,2-propylene glycol, ethylene carbonate, propylene carbonate or mixtures thereof.

Frequently, the concentration of the cosolvent in the aqueous postcrosslinker solution is from 15 to 50% by weight, preferably from 15 to 40% by weight and more preferably from 20 to 35% by weight, based on the postcrosslinker solution. In the case of cosolvents which have only limited miscibility with water, the aqueous postcrosslinker solution will advantageously be adjusted such that only one phase is present, optionally by lowering the concentration of the cosolvent.

In a preferred embodiment, no cosolvent is used. The postcrosslinker is then employed only as a solution in water, optionally with addition of a deagglomeration assistant.

The concentration of the at least one postcrosslinker in the aqueous postcrosslinker solution is typically from 1 to 20% by weight, preferably from 1.5 to 10% by weight and more preferably from 2 to 5% by weight, based on the postcrosslinker solution.

The total amount of the postcrosslinker solution based on base polymer is typically from 0.3 to 15% by weight and preferably from 2 to 6% by weight.

The actual surface postcrosslinking by reaction of the surface postcrosslinker with functional groups at the surface of the base polymer particles is usually carried out by heating the base polymer wetted with surface postcrosslinker solution, typically referred to as “drying” (but not to be confused with the above-described drying of the polymer gel from the polymerization, in which typically very much more liquid has to be removed). The drying can be effected in the mixer itself, by heating the jacket, by means of heat exchange surfaces or by blowing in warm gases. Simultaneous admixing of the superabsorbent with surface postcrosslinker and drying can be effected, for example, in a fluidized bed drier. The drying is, however, usually carried out in a downstream drier, for example a tray drier, a rotary tube oven, a paddle or disk drier or a heatable screw. Suitable driers are obtainable, for example, as Solidair® or Torusdisc® driers from Bepex International LLC, 333 N.E. Taft Street, Minneapolis, Minn. 55413, U.S.A., or as paddle or shovel driers or else as fluidized bed driers from Nara Machinery Co., Ltd., European office, Europaallee 46, 50226 Frechen, Germany.

It is possible to heat the polymer particles by means of contact surfaces in a downstream drier for the purpose of drying and performing the surface postcrosslinking, or by means of warm inert gas supply, or by means of a mixture of one or more inert gases with steam, or only with steam alone. In the case of supply of the heat by means of contact surfaces, it is possible to perform the reaction under inert gas at slightly or completely reduced pressure. In the case of use of steam for direct heating of the polymer particles, it is desirable in accordance with the invention to operate the drier under standard pressure or elevated pressure. In this case, it may be advisable to split up the postcrosslinking step into a heating step with steam and a reaction step under inert gas but without steam. This can be achieved in one or more apparatuses. According to the invention, the polymer particles can be heated with steam as early as in the postcrosslinking mixer. The base polymer used may still have a temperature of from 10 to 120° C. from preceding process steps; the postcrosslinker solution may have a temperature of from 0 to 70° C. In particular, the postcrosslinker solution can be heated to reduce the viscosity.

Preferred drying temperatures are in the range of 100 to 250° C., preferably 120 to 220° C., more preferably 130 to 210° C. and most preferably 150 to 200° C. The preferred residence time at this temperature in the reaction mixer or drier is preferably at least 10 minutes, more preferably at least 20 minutes, most preferably at least 30 minutes, and typically at most 60 minutes. Typically, the drying is conducted such that the superabsorbent has a residual moisture content of generally at least 0.1% by weight, preferably at least 0.2% by weight and most preferably at least 0.5% by weight, and generally at most 15% by weight, preferably at most 10% by weight and more preferably at most 8% by weight.

The postcrosslinking may take place under standard atmospheric conditions. “Standard atmospheric conditions” means that no technical precautions are taken in order to reduce the partial pressure of oxidizing gases, such as that of atmospheric oxygen, in the apparatus in which the postcrosslinking reaction predominantly takes place (the “postcrosslinking reactor”, typically the drier). However, preference is given to performing the postcrosslinking reaction under reduced partial pressure of oxidizing gases. Oxidizing gases are substances which, at 23° C., have a vapor pressure of at least 1013 mbar and act as oxidizing agents in combustion processes, for example oxygen, nitrogen oxide and nitrogen dioxide, especially oxygen. The partial pressure of oxidizing gases is preferably less than 140 mbar, preferably less than 100 mbar, more preferably less than 50 mbar and most preferably less than 10 mbar. When the thermal postcrosslinking is carried out at ambient pressure, i.e. at a total pressure around 1013 mbar, the total partial pressure of the oxidizing gases is determined by their proportion by volume. The proportion of the oxidizing gases is preferably less than 14% by volume, preferably less than 10% by volume, more preferably less than 5% by volume and most preferably less than 1% by volume.

The postcrosslinking can be carried out under reduced pressure, i.e. at a total pressure of less than 1013 mbar. The total pressure is typically less than 670 mbar, preferably less than 480 mbar, more preferably less than 300 mbar and most preferably less than 200 mbar. When drying and postcrosslinking are carried out under air with an oxygen content of 20.8% by volume, the partial oxygen pressures corresponding to the abovementioned total pressures are 139 mbar (670 mbar), 100 mbar (480 mbar), 62 mbar (300 mbar) and 42 mbar (200 mbar), the respective total pressures being in the brackets. Another means of lowering the partial pressure of oxidizing gases is the introduction of nonoxidizing gases, especially inert gases, into the apparatus used for postcrosslinking. Suitable inert gases are substances which are present in gaseous form in the postcrosslinking drier at the postcrosslinking temperature and the given pressure and do not have an oxidizing action on the constituents of the drying polymer particles under these conditions, for example nitrogen, carbon dioxide, argon, steam, preference being given to nitrogen. The amount of inert gas is generally from 0.0001 to 10 m³, preferably from 0.001 to 5 m³, more preferably from 0.005 to 1 m³ and most preferably from 0.005 to 0.1 m³, based on 1 kg of superabsorbent.

In the process according to the invention, the inert gas, if it does not comprise steam, can be blown into the postcrosslinking drier via nozzles; however, particular preference is given to adding the inert gas to the polymer particle stream via nozzles actually within or just upstream of the mixer, by admixing the superabsorbent with surface postcrosslinker.

It will be appreciated that vapors of cosolvents removed from the drier can be condensed again outside the drier and optionally recycled.

In a preferred embodiment of the present invention, polyvalent cations are applied to the particle surface in addition to the postcrosslinkers before, during or after the postcrosslinking. This is in principle a further surface postcrosslinking by means of ionic noncovalent bonds, but is occasionally also referred to as “complexation” with the metal ions in question or simply as “coating” with the substances in question (the “complexing agent”).

This application of polyvalent cations is effected by spray application of solutions of di- or polyvalent cations, usually di-, tri- or tetravalent metal cations, but also polyvalent cations such as polymers formed, in a formal sense, entirely or partly from vinylamine monomers, such as partly or fully hydrolyzed polyvinylamide (so-called “polyvinylamine”), whose amine groups are always—even at very high pH values—present partly in protonated form to give ammonium groups. Examples of usable divalent metal cations are especially the divalent cations of metals of groups 2 (especially Mg, Ca, Sr, Ba), 7 (especially Mn), 8 (especially Fe), 9 (especially Co), 10 (especially Ni), 11 (especially Cu) and 12 (especially Zn) of the Periodic Table of the Elements. Examples of usable trivalent metal cations are especially the trivalent cations of metals of groups 3 including the lanthanides (especially Sc, Y, La, Ce), 8 (especially Fe), 11 (especially Au), 13 (especially Al) and 14 (especially Bi) of the Periodic Table of the Elements. Examples of usable tetravalent cations are especially the tetravalent cations of metals from the lanthanides (especially Ce) and group 4 (especially Ti, Zr, Hf) of the Periodic Table of the Elements. The metal cations can be used either alone or as a mixture with one another. Particular preference is given to the use of trivalent metal cations. Very particular preference is given to the use of aluminum cations.

Among the metal cations mentioned, suitable metal salts are all of those which possess sufficient solubility in the solvent to be used. Especially suitable are metal salts with weakly complexing anions such as, for example, chloride, nitrate and sulfate, hydrogensulfate, carbonate, hydrogencarbonate, nitrate, phosphate, hydrogenphosphate or dihydrogenphosphate. Preference is given to salts of mono- and dicarboxylic acids, hydroxy acids, keto acids and amino acids, or basic salts. Preferred examples include acetates, propionates, tartrates, maleates, citrates, lactates, malates, succinates Likewise preferred is the use of hydroxides. Particular preference is given to the use of 2-hydroxycarboxylic salts such as citrates and lactates. Examples of particularly preferred metal salts are alkali metal and alkaline earth metal aluminates and hydrates thereof, for instance sodium aluminate and hydrates thereof, alkali metal and alkaline earth metal lactates and citrates and hydrates thereof, aluminum acetate, aluminum propionate, aluminum citrate and aluminum lactate.

The cations and salts mentioned can be used in pure form or as a mixture of different cations or salts. The salts of the di- and/or trivalent metal cation used may comprise further secondary constituents such as still unneutralized carboxylic acid and/or alkali metal salts of the neutralized carboxylic acid. Preferred alkali metal salts are those of sodium and potassium, and those of ammonium. They are typically used in the form of an aqueous solution which is obtained by dissolving the solid salts in water, or is preferably obtained directly as such, which avoids any drying and purification steps. Advantageously, it is also possible to use the hydrates of the salts mentioned, which often dissolve more rapidly in water than the anhydrous salts.

The amount of metal salt used is generally at least 0.001% by weight, preferably at least 0.01% by weight and more preferably at least 0.1% by weight, for example at least 0.4% by weight, and generally at most 5% by weight, preferably at most 2.5% by weight and more preferably at most 1% by weight, for example at most 0.7% by weight, based in each case on the mass of the base polymer.

The salt of the trivalent metal cation can be used in the form of a solution or suspension. Solvents for the metal salts which may be employed are water, alcohols, DMF, DMSO and mixtures of these components. Particular preference is given to water and water/alcohol mixtures, for example water/methanol, water/1,2-propanediol and water/1,3-propanediol.

The treatment of the base polymer with solution of a di- or polyvalent cation is carried out in the same manner as the treatment with surface postcrosslinker, including the drying step. Surface postcrosslinker and polyvalent cation can be sprayed on in a combined solution or as separate solutions. The spray application of the metal salt solution to the superabsorbent particles may either precede or follow the surface postcrosslinking. In a particularly preferred process, the spray application of the metal salt solution is effected in the same step together with the spray application of the crosslinker solution, in which case the two solutions are sprayed on separately in succession or simultaneously via two nozzles, or crosslinker solution and metal salt solution can be sprayed on jointly via one nozzle.

Especially when a trivalent or higher-valency metal cation such as aluminum is used for complexation, a basic salt of a divalent metal cation or a mixture of such salts is also optionally added. Basic salts are salts which are suitable for increasing the pH of an aqueous acidic solution, preferably 0.1 N hydrochloric acid. Basic salts are typically salts of a strong base with a weak acid.

The divalent metal cation of the optional basic salt is preferably a metal cation of group 2 of the Periodic Table of the Elements, more preferably calcium or strontium, most preferably calcium.

The basic salts of the divalent metal cations are preferably salts of weak inorganic acids, of weak organic acids and/or salts of amino acids, more preferably hydroxides, hydrogencarbonates, carbonates, acetates, propionates, citrates, gluconates, lactates, tartrates, malates, succinates, maleates and/or fumarates, most preferably hydroxides, hydrogencarbonates, carbonates, propionates and/or lactates. The basic salt is preferably water-soluble. Water-soluble salts are salts which, at 20° C., have a water solubility of at least 0.5 g of salt per liter of water, preferably at least 1 g of salt per 1 of water, more preferably at least 10 g of salt per 1 of water, especially preferably at least 100 g of salt per 1 of water and very especially preferably at least 200 g of salt per 1 of water. However, it is also possible in accordance with the invention to use those salts which have this minimum solubility at the spray application temperature of the spray solution. Advantageously, it is also possible to use the hydrates of the salts mentioned, which often dissolve more rapidly in water than the anhydrous salts.

Suitable basic salts of divalent metal cations are, for example, calcium hydroxide, strontium hydroxide, calcium hydrogencarbonate, strontium hydrogencarbonate, calcium acetate, strontium acetate, calcium propionate, calcium lactate, strontium propionate, strontium lactate, zinc lactate, calcium carbonate and strontium carbonate.

When the water solubility is insufficient to prepare a spray solution of the desired concentration, it is also possible to use dispersions of the solid salt in a saturated aqueous solution thereof. For example, it is also possible to use calcium carbonate, strontium carbonate, calcium sulfite, strontium sulfite, calcium phosphate and strontium phosphate in the form of aqueous dispersions.

The amount of basic salt of the divalent metal cation, based on the mass of the base polymer, is typically from 0.001 to 5% by weight, preferably from 0.01 to 2.5% by weight, more preferably from 0.1 to 1.5% by weight, especially preferably from 0.1 to 1% by weight and very especially preferably from 0.4 to 0.7% by weight.

The basic salt of the divalent metal cation can be used in the form of a solution or suspension. Examples thereof are calcium lactate solutions or calcium hydroxide suspensions. Typically, the salts are sprayed on with an amount of water of not more than 15% by weight, preferably of not more than 8% by weight, more preferably of not more than 5% by weight and most preferably of not more than 2% by weight, based on the superabsorbent.

Preference is given to spraying an aqueous solution of the basic salt onto the superabsorbent. Conveniently, the basic salt is added simultaneously with the surface postcrosslinking agent, the complexing agent or as a further constituent of the solutions of these agents. For these basic salts, preference is given to addition in a mixture with the complexing agent. When the solution of the basic salt is not miscible with the solution of the complexing agent without precipitation, the solutions can be sprayed on separately in succession or simultaneously from two nozzles.

A reducing compound is optionally also added to the superabsorbent. Examples of reducing compounds are hypophosphites, sulfinates, sulfites, sulfonic acid derivatives or sulfinic acid derivatives, as obtainable, for example, in the form of the disodium salt of 2-hydroxy-2-sulfonatoacetic acid under the BLANCOLEN® HP name or in the form of mixtures of the sodium salt of 2-hydroxy-2-sulfinatoacetic acid, the disodium salt of 2-hydroxy-2-sulfonatoacetic acid and sodium bisulfite under the BRÜGGOLIT® FF6M or BRÜGGOLIT® FF7 names, or alternatively BRUGGOLITE® FF6M or BRUGGOLITE® FF7 from L. Brüggemann KG (Salzstrasse 131, 74076 Heilbronn, Germany, www.brueggemann.com).

The addition of one or more reducing compounds to the superabsorbent is effected in a customary manner, by addition of the compound in substance, as a solution or as a suspension in a solvent or suspension medium, during or after the production of the superabsorbent. Typically, a solution or suspension of the reducing compound in water or an organic solvent is used, for example in an alcohol or polyol or in mixtures thereof. Examples of suitable solvents or suspension media are water, isopropanol/water, 1,3-propanediol/water and propylene glycol/water, where the mixing ratio by mass is preferably from 20:80 to 40:60. A surfactant can be added to the solution or suspension. If reducing compounds are added, they are generally added in an amount of at least 0.0001% by weight, preferably at least 0.001% by weight and more preferably at least 0.025% by weight, for example at least 0.1% by weight or at least 0.3% by weight, and generally at most 3% by weight, preferably at most 2.5% by weight and more preferably at most 1.5% by weight, for example at most 1% by weight or 0.7% by weight, based in each case on the total weight of the superabsorbent.

The reducing compound is generally mixed with the superabsorbent known per se in exactly the same way as the solution or suspension which comprises a surface postcrosslinker and is applied to the superabsorbent for surface postcrosslinking. The reducing compound can be applied to a base polymer as a constituent of the solution applied for surface postcrosslinking or of one of the components thereof, i.e. added to the solution of the surface postcrosslinker or of one of the components thereof. The superabsorbent coated with surface postcrosslinking agent and reducing compound then passes through the further process steps required for surface postcrosslinking, for example a thermally induced reaction of the surface postcrosslinking agent with the superabsorbent. This process is comparatively simple and economically viable.

If ultrahigh stability to discoloration over the course of prolonged storage is essential, the reducing compound is preferably applied in a dedicated process step after the surface postcrosslinking. If it is applied in the form of a solution or suspension, the application to the already surface postcrosslinked superabsorbent is effected in the same way as the application of the surface postcrosslinking agent to the base polymer. Usually, but not necessarily, this is followed by heating, just like in the surface postcrosslinking step, in order to dry the superabsorbent again. The temperature established in this drying step is then, however, generally at most 110° C., preferably at most 100° C. and more preferably at most 90° C., in order to prevent undesired reactions of the reducing compound. The temperature is adjusted such that, in view of the residence time in the drying unit, the desired water content of the superabsorbent is achieved. It is also entirely possible and convenient to add the reducing compound individually or together with other customary assistants, for example antidusting agents, viz. the pyrogenic aluminum oxide to be added in accordance with the invention, other anticaking agents or water to remoisturize the superabsorbent, as described below for these assistants, for example in a cooler connected downstream of the surface postcrosslinking step. The temperature of the polymer particles in this case is between 0° C. and 190° C., preferably less than 160° C., more preferably less than 130° C., even more preferably less than 100° C. and most preferably less than 70° C. The polymer particles are optionally cooled rapidly after coating to temperatures below the decomposition temperature of the reducing compound.

If a drying step is carried out after the surface postcrosslinking and/or treatment with complexing agent, it is advantageous but not absolutely necessary to cool the product after the drying. The cooling can be effected continuously or batchwise; to this end, the product is conveniently conveyed continuously into a cooler arranged downstream of the drier. Any apparatus known for removal of heat from pulverulent solids can be used for this purpose, more particularly any device mentioned above as drying apparatus, except that it is charged not with a heating medium but with a cooling medium, for example with cooling water, such that no heat is introduced into the superabsorbent via the walls and, according to the construction, also via the stirring elements or other heat exchange surfaces, and is instead removed therefrom. Preference is given to the use of coolers in which the product is moved, i.e. cooled mixers, for example shovel coolers, disk coolers or paddle coolers. The superabsorbent can also be cooled in a fluidized bed by injecting a cooled gas such as cold air. The cooling conditions are adjusted so as to obtain a superabsorbent with the temperature desired for further processing. Typically, a mean residence time in the cooler of generally at least 1 minute, preferably at least 3 minutes and more preferably at least 5 minutes, and generally at most 6 hours, preferably at most 2 hours and more preferably at most 1 hour is established, and the cooling performance is such that the product obtained has a temperature of generally at least 0° C., preferably at least 10° C. and more preferably at least 20° C., and generally at most 100° C., preferably at most 80° C. and more preferably at most 60° C.

The surface postcrosslinked superabsorbent is optionally ground and/or sieved in a customary manner. Grinding is typically not required here, but the removal by sieving of agglomerates or fines formed is usually appropriate for establishment of the desired particle size distribution of the product. Agglomerates and fines are either discarded or preferably recycled into the process in a known manner at a suitable point; agglomerates after comminution. The particle sizes desired for surface postcrosslinked superabsorbents are the same as for base polymers.

To produce the inventive superabsorbent, in the process according to the invention, pyrogenic aluminum oxide is added to the particulate superabsorbent as an additive. The addition is accordingly effected at a time at which particulate superabsorbent is already present, i.e. no earlier than after the polymerization, preferably after the drying and more preferably after the surface postcrosslinking. A particularly simple option is the addition of the pyrogenic aluminum oxide in the cooler, for instance by spray application of a dispersion or addition in fine solid form.

It is optionally possible to additionally apply to the superabsorbent, whether unpostcrosslinked or postcrosslinked, in any process step of the preparation process, if required, all other known coatings and other additives, such as film-forming polymers, thermoplastic polymers, dendrimers, polycationic polymers (for example polyvinylamine, polyethyleneimine or polyallylamine), water-insoluble polyvalent metal salts, for example magnesium carbonate, magnesium oxide, magnesium hydroxide, calcium carbonate, calcium sulfate or calcium phosphate, all water-soluble mono- or polyvalent metal salts known to those skilled in the art, for example aluminum sulfate, sodium salts, potassium salts, zirconium salts or iron salts, or hydrophilic inorganic particles other than pyrogenic aluminum oxide, such as clay minerals, fumed silica, colloidal silica sols, for example Levasil®, titanium dioxide, nonpyrogenic aluminum oxide and magnesium oxide. Examples of useful alkali metal salts are sodium and potassium sulfate, and sodium and potassium lactates, citrates and sorbates. This allows additional effects, for example another reduction in the caking tendency of the end product or of the intermediate in the particular process step of the production process, improved processing properties or a further enhanced liquid permeability in the swollen gel, to be achieved. When the additives are used and sprayed on in the form of dispersions, they are preferably used as aqueous dispersions, and preference is given to additionally applying an antidusting agent to fix the additive on the surface of the superabsorbent. The antidusting agent is then either added directly to the dispersion of the inorganic pulverulent additive; optionally, it can also be added as a separate solution before, during or after the application of the inorganic pulverulent additive by spray application. Most preferred is the simultaneous spray application of postcrosslinking agent, antidusting agent and pulverulent inorganic additive in the postcrosslinking step. In a further preferred process variant, the antidusting agent is, however, added separately in the cooler, for example by spray application from above, below or from the side. Particularly suitable antidusting agents which can also serve to fix pulverulent inorganic additives on the surface of the superabsorbent particles are polyethylene glycols with a molecular weight of 400 to 20 000 g/mol, polyglycerol, 3- to 100-tuply ethoxylated polyols, such as trimethylolpropane, glycerol, sorbitol and neopentyl glycol. Particularly suitable are 7- to 20-tuply ethoxylated glycerol or trimethylolpropane, for example Polyol TP 70® (Perstorp, Sweden). The latter have the advantage, more particularly, that they lower the surface tension of an aqueous extract of the superabsorbent particles only insignificantly.

It is equally possible to adjust the inventive superabsorbent to a desired water content by adding water.

The chelating agents mentioned above in the course of the description of the composition of the monomer solution can be added anywhere in the process for producing the inventive superabsorbent.

Equally, the reducing agents mentioned above in the context of the composition of the monomer solution can be added anywhere in the process for producing the inventive superabsorbent. It is often even advantageous to add these additives to the finished superabsorbent together with the other additives.

All coatings, solids, additives and assistants can each be added in separate process steps, but the most convenient method is usually to add them—if they are not added during the admixing of the base polymer with surface postcrosslinking agent—to the superabsorbent in the cooler, for instance by spray application of a solution or dispersion, or addition in fine solid form or in liquid form.

It is also possible to produce inventive superabsorbents by mixing a superabsorbent having a high content of additives, for instance the pyrogenic aluminum oxide to be added in accordance with the invention, but also other additives, or only other additives, with a superabsorbent lacking such additives or having a relatively low content of such additives, such that the overall result is the superabsorbent with the desired additive content. This procedure is known as the “masterbatch” technique and is an option anywhere where no apparatus is available for mixing of the superabsorbent obtained overall with the usually relatively small amounts of additives, but apparatus is available for mixing of the superabsorbent obtained overall with the much greater amounts of “masterbatch” superabsorbent compared to the amount of pure additive. Such stepwise mixing of the additives into the total amount of superabsorbent can thus be technically simpler overall.

Such superabsorbents with additive materials added after polymerization, drying or surface postcrosslinking are, incidentally, referred to in customary parlance not only as “superabsorbents with additive material”, but also as “superabsorbents coated with the additive”, “superabsorbents comprising the additive material”, or as a “composition of superabsorbent and additive material”. These are synonyms in practice.

The inventive superabsorbent generally has a centrifuge retention capacity (CRC) of at least 5 g/g, preferably of at least 10 g/g and more preferably of at least 20 g/g. Further suitable minimum CRC values are, for example, 25 g/g or 30 g/g. It is typically not more than 40 g/g. A typical CRC range for surface postcrosslinked superabsorbents is from 28 to 33 g/g.

The inventive superabsorbent, if it has been surface postcrosslinked, typically has an absorption against pressure (AAP (0.7psi), for test method see below) of at least 18 g/g, preferably at least 19 g/g, more preferably at least 20 g/g and typically not more than 30 g/g.

The present invention further provides hygiene articles comprising the inventive superabsorbent comprising pyrogenic aluminum oxide, preferably ultrathin diapers, comprising an absorbent layer consisting of 50 to 100% by weight, preferably 60 to 100% by weight, more preferably 70 to 100% by weight, especially preferably 80 to 100% by weight and very especially preferably 90 to 100% by weight of inventive superabsorbent, of course not including the envelope of the absorbent layer.

Very particularly advantageously, the inventive superabsorbents are also suitable for production of laminates and composite structures, as described, for example, in US 2003/0181115 and US 2004/0019342. In addition to the hotmelt adhesives described in both documents for production of such novel absorbent structures, and especially the fibers, described in US 2003/0181115, composed of hotmelt adhesives to which the superabsorbent particles are bound, the inventive superabsorbents are also suitable for production of entirely analogous structures using UV-crosslinkable hotmelt adhesives, which are sold, for example, as AC-Resin® (BASF SE, Carl-Bosch-Strasse 38, 67056 Ludwigshafen, Germany). These UV-crosslinkable hotmelt adhesives have the advantage of already being processable at 120 to 140° C.; they therefore have better compatibility with many thermoplastic substrates. A further significant advantage is that UV-crosslinkable hotmelt adhesives are very safe in toxicological terms and also do not cause any evaporation in the hygiene articles. A very significant advantage in connection with the inventive superabsorbents is the property of the UV-crosslinkable hotmelt adhesives of not tending to yellow during processing and crosslinking. This is especially advantageous when ultrathin or partly transparent hygiene articles are to be produced. The combination of the inventive superabsorbents with UV-crosslinkable hotmelt adhesives is therefore particularly advantageous. Suitable UV-crosslinkable hotmelt adhesives are described, for example, in EP 0 377 199 A2, EP 0 445 641 A1, U.S. Pat. No. 5,026,806, EP 0 655 465 A1 and EP 0 377 191 A2.

The inventive superabsorbent can also be used in other fields of industry in which liquids, especially water or aqueous solutions, are absorbed. These fields are, for example, storage, packaging, transport (as constituents of packaging material for water- or moisture-sensitive articles, for instance for flower transport, and also as protection against mechanical effects); animal hygiene (in cat litter); food packaging (transport of fish, fresh meat; absorption of water, blood in fresh fish or meat packaging); medicine (wound plasters, water-absorbing material for burn dressings or for other weeping wounds), cosmetics (carrier material for pharmaceutical chemicals and medicaments, rheumatic plasters, ultrasonic gel, cooling gel, cosmetic thickeners, sunscreen); thickeners for oil/water or water/oil emulsions; textiles (moisture regulation in textiles, shoe insoles, for evaporative cooling, for instance in protective clothing, gloves, headbands); chemical engineering applications (as a catalyst for organic reactions, for immobilization of large functional molecules such as enzymes, as an adhesive in agglomerations, heat stores, filtration aids, hydrophilic components in polymer laminates, dispersants, liquefiers); as assistants in powder injection molding, in the building and construction industry (installation, in loam-based renders, as a vibration-inhibiting medium, assistants in tunnel excavations in water-rich ground, cable sheathing); water treatment, waste treatment, water removal (deicers, reusable sand bags); cleaning; agrochemical industry (irrigation, retention of melt water and dew deposits, composting additive, protection of forests from fungal/insect infestation, retarded release of active ingredients to plants); for firefighting or for fire protection; coextrusion agents in thermoplastic polymers (for example for hydrophilization of multilayer films); production of films and thermoplastic moldings which can absorb water (e.g. films which store rain and dew for agriculture; films comprising superabsorbents for maintaining freshness of fruit and vegetables which are packaged in moist films; superabsorbent-polystyrene coextrudates, for example for packaging foods such as meat, fish, poultry, fruit and vegetables); or as a carrier substance in active ingredient formulations (pharmaceuticals, crop protection).

The inventive articles for absorption of liquid differ from known examples in that they comprise the inventive superabsorbent.

Also found has been a process for producing articles for absorption of liquid, especially hygiene articles, which comprises using at least one inventive superabsorbent in the production of the article in question. In addition, processes for producing such articles using superabsorbent are known.

### TEST METHODS

The superabsorbent is tested by the test methods described below.

The standard test methods described hereinafter and designated “WSP” are described in: “Standard Test Methods for the Nonwovens Industry”, 2011 edition, published jointly by the Worldwide Strategic Partners EDANA (European Disposables and Nonwovens Association, Avenue Eugene Plasky, 157, 1030 Brussels, Belgium, www.edana.org) and INDA (Association of the Nonwoven Fabrics Industry, 1100 Crescent Green, Suite 115, Cary, N.C. 27518, U.S.A., www.inda.org). This publication is available both from EDANA and from INDA.

All measurements described below should, unless stated otherwise, be conducted at an ambient temperature of 23±2° C. and a relative air humidity of 50±10%. The superabsorbent particles are mixed thoroughly before the measurement unless stated otherwise.

### Centrifuge Retention Capacity (CRC)

The centrifuge retention capacity of the superabsorbent is determined to standard test method No. WSP 241.3 (10) “Determination of the Fluid Retention Capacity in Saline Solution by Gravimetric Measurement Following Centrifugation”.

### Absorption Against Pressure of 0.7 psi (AAP (0.7 psi))

The absorption under a pressure of 4826 Pa (0.7 psi) of the superabsorbent is determined analogously to standard test method No. WSP 242.3 (10) “Determination of the Absorption Against Pressure of Saline Solution by Gravimetric Measurement”, except using a weight of 49 g/cm² (leads to a pressure of 4826 Pa=0.7 psi) rather than a weight of 21 g/cm² (leads to a pressure of 2068 Pa=0.3 psi).

### Vortex Test

50.0 ml±1.0 ml of a 0.9% by weight aqueous sodium chloride solution are introduced into a 100 ml beaker which comprises a magnetic stirrer bar of size 30 mm×6 mm. The temperature of the sodium chloride solution is 23° C.±0.5° C. A magnetic stirrer is used to stir the sodium chloride solution at 600 rpm. Then 2.000 g±0.010 g of superabsorbent granules (either a fraction obtained by sieving with particle sizes of 300 to 400 μm or without sieving (i.e. the entire particle spectrum of the superabsorbent to be subjected to the vortex test without sieving off a particular particle fraction), as specified in each case below) are added as rapidly as possible, and the time taken for the stirring vortex to disappear due to the absorption of the sodium chloride solution by the superabsorbent granules is measured. When measuring this time, the entire contents of the beaker may still be rotating as a homogeneous gel mass, but the surface of the gelated sodium chloride solution must no longer exhibit any individual turbulences. The time taken is reported as the vortex.

### Anticaking Test

5.0±0.01 g of superabsorbent granules are weighed into an aluminum pan of diameter 57 mm, height 1.5 mm and the predetermined weight W_{d}. By gently tapping the aluminum pan, the superabsorbent granules are distributed homogeneously. The aluminum pan containing the superabsorbent granules is placed into a climate-controlled cabinet at a temperature of 30° C. and a relative air humidity of 80%. After 1 or 3 hours, the aluminum pan containing the superabsorbent granules is taken out of the climate-controlled cabinet and weighed; the weight is noted as W_{HYD}. Subsequently, a sieve with a diameter of 76.2 mm (=3 inches), a height of 22 mm and a mesh size of 1.7 mm, and a sieve plate which fits it, the weight of which has been determined beforehand and noted as W_{PAN}, is placed over the aluminum pan containing the superabsorbent granules and the whole arrangement is cautiously turned upside down, such that the sieve plate is now at the bottom and the aluminum pan at the top. A fitting sieve cover is placed onto the sieve comprising the aluminum pan containing the superabsorbent granules and the whole arrangement is clamped into a sieving machine (Retsch AS 200 control, available from Retsch GmbH, Rheinische Strasse 36, 42781 Haan, Germany). The sieving is effected at a set amplitude of 0.20 mm for 1 minute. The arrangement is removed from the sieving machine, and the sieve plate is cautiously removed and weighed; the weight is noted as W_{UNC} The proportion of caked superabsorbent granules is calculated by:

Caking [%]=100−((W_{UNC}−W_{PAN})/(W_{HYD}−W_{d})*100)

### EXAMPLES

### Example 1

Commercially available superabsorbent (HySorb® B 7015 from BASF SE, Carl-Bosch-Strasse 38, 67056 Ludwigshafen, Germany) was sieved to remove particles having a diameter greater than 600 μm. 100 g in each case of the material sieved off were introduced into a PE sample bottle (capacity 500 ml), and 0.25 g in each case of the substances specified in table 1 was added. The contents of the bottle were mixed intimately with a tumbling mixer (T2C; Willy A. Bachofen AG Maschinenfabrik, Basle; Switzerland) for 8 minutes. The test results for the superabsorbents thus obtained are reported in table 1.

TABLE 1
Characterization of the superabsorbents obtained in example 1.
Comparative tests are indicated by (C).

| | | | Vortex | | |
|---|---|---|---|---|---|
| | | AAP | (300-400 | Caking | Caking |
| | CRC | (0.7 psi) | μm) | 1 h | 3 h |
| Additive | [g/g] | [g/g] | [s] | [%] | [%] |
| none | 31.7 | 21.4 | 70 | 100 | 100 |
| Aeroxide ® Alu C | 32.3 | 20.9 | 57 | 20 | 79 |
| Aeroxide ® Alu 65 | 31.8 | 20.7 | 54 | 13 | 58 |
| Aeroxide ® Alu 130 | 32.6 | 21.0 | 53 | 0.5 | 26 |
| Sipernat ® D-17 (C) | 32.0 | 17.4 | 82 | 0.4 | 13 |
| Aerosil ® 200 (C) | 32.1 | 17.2 | 58 | 35 | 91 |
| Sipernat ® 22S (C) | 32.0 | 17.8 | 59 | 41 | 97 |
| Aerosil ® R 106 (C) | 32.3 | 17.0 | 84 | 0.3 | 9 |
| Disperal ® (C) | 31.8 | 20.0 | 64 | 72 | 100 |
| Pural ® SB (C) | 31.6 | 19.7 | 66 | 80 | 100 |
| Pural ® 200 (C) | 32.5 | 19.8 | 62 | 75 | 100 |
| Catapal C1 (C) | 32.4 | 19.6 | 63 | 83 | 100 |
| Puralox ® SCFa140 (C) | 31.8 | 19.0 | 59 | 82 | 100 |
| activated aluminum | 32.6 | 19.1 | 61 | 85 | 100 |
| oxide, neutral, | | | | | |
| Brockmann I (C) | | | | | |
| activated aluminum | 32.7 | 19.2 | 60 | 87 | 100 |
| oxide, acidic, | | | | | |
| Brockmann I (C) | | | | | |

Aeroxide® Alu C: pyrogenic aluminum oxide with a BET surface area of 100 m²/g

Aeroxide® Alu 65: pyrogenic aluminum oxide with a BET surface area of 65 m²/g,

Aeroxide® Alu 130: pyrogenic aluminum oxide with a BET surface area of 130 m²/g

Aerosil® 200: hydrophilic fumed silica with a BET surface area of 200 m²/g

Sipernat® 22S: hydrophilic precipitated silica with a BET surface area of 200 m²/g

Sipernat® D17: hydrophobized precipitated silica with a BET surface area of 100 m²/g

Aerosil® R106: hydrophobized fumed silica with a BET surface area of 250 m²/g

The substances designated Aeroxide®, Aerosil® or Sipernat® are available from Evonik Industries AG, Inorganic Materials, Rodenbacher Chaussee 4, 63457 Hanau-Wolfgang, Germany.

Disperal®: dispersible colloidal boehmite with a BET surface area of 180 m²/g

Pural® SB: high-purity boehmite with a BET surface area of 250 m²/g

Pural® 200: high-purity boehmite with a BET surface area of 100 m²/g

Catapal® Cl: high-purity boehmite with a BET surface area of 230 m²/g

Puralox® SCFa140: high-purity aluminum oxide with a BET surface area of 140 m²/g

The substances designated Disperal®, Pural®, Puralox® or Catapal® are available from Sasol Germany GmbH, Anckelmannsplatz 1, 20537 Hamburg, Germany.

aluminum oxide,

activated, neutral,

Brockmann I: alumina with a BET surface area of 150 m²/g

aluminum oxide,

activated, acidic,

Brockmann I: alumina with a BET surface area of 150 m²/g

The activated aluminum oxides are available from Sigma-Aldrich Laborchemikalien GmbH, Wunstorferstrasse 40, 30926 Seelze, Germany.

The comparative values in table 1 show that precipitated aluminum oxides have virtually no effect as anticaking agents, but pyrogenic aluminum oxides can achieve the same effect as anticaking agents as fumed silica, but they do not worsen the absorption properties, more particularly the AAP (0.7 psi), to the same extent as these. In addition, they lead to a desirably rapid water absorption (shorter “vortex” time).

### Example 2

A 21 stainless steel beaker was initially charged with 326.7 g of 50% by weight sodium hydroxide solution and 675 g of frozen deionized water. 392.0 g of acrylic acid were added while stirring, in the course of which the rate of addition was adjusted such that the temperature did not exceed 35° C. The mixture was then cooled with stirring and the aid of a cooling bath. When the temperature of the mixture had fallen to 20° C., 0.90 g of Laromer® LR 9015X (trimethylolpropane-15EO triacrylate from BASF SE, Ludwigshafen, Germany), 0.037 g of 2-hydroxy-2-methyl-1-phenylpropan-1-one (DAROCUR® 1173 from BASF SE, Ludwigshafen, Germany) and 0.018 g of 2,2-dimethoxy-1,2-diphenylethan-1-one (IRGACURE® 651 from BASF SE, Ludwigshafen, Germany) were added. Cooling was continued, and on attainment of 15° C. the mixture was freed of oxygen by passing nitrogen through by means of a glass frit. On attainment of 0° C., 0.45 g of sodium persulfate (dissolved in 5 ml of water) and 0.06 g of hydrogen peroxide (dissolved in 6 ml of water) were added, and the monomer solution was transferred into a glass dish. The glass dish had such dimensions as to establish a layer thickness of the monomer solution of 5 cm. Subsequently, 0.047 g of Bruggolite® FF7 (dissolved in 5 ml of water), from L. Brüggemann KG, Salzstrasse 131, 74076 Heilbronn, Germany was added and the monomer solution was stirred briefly with the aid of a glass rod. The glass dish containing the monomer solution was placed under a UV lamp (UV intensity=20 mW/cm²), and polymerization set in. After 16 minutes, the resulting gel was ground three times with the aid of a commercial meat grinder with a 6 mm die plate, and dried in a laboratory drying cabinet at 160° C. for one hour. The product was then ground and sieved to obtain the sieve fraction from 150 to 600 μm.

For surface postcrosslinking, the polymer thus prepared was coated in a Pflugschar® mixer with a heating jacket (manufacturer: Gebr. Lödige Maschinenbau GmbH, Elsener-Strasse 7-9, 33102 Paderborn, Germany; M5 model) at room temperature and a shaft speed of 250 revolutions per minute by means of a two-substance spray nozzle with a solution of the following composition, the proportions by weight each being based on the coated polymer:

0.20% by weight of HEONON (=2-hydroxyethyloxazolidinone)/1,3-propanediol mixture (1:1),

1.80% by weight of 1,2-propanediol,

0.5% by weight of water, and

2.0% by weight of aqueous aluminum trilactate solution (22% by weight).

After the spray application, the product temperature was increased to 170° C. and the reaction mixture was held at this temperature and a shaft speed of 60 revolutions per minute for 90 minutes. The resulting product was allowed to cool back to room temperature and sieved to obtain the sieve fraction from 150 to 600 μm. The superabsorbent had the following properties:

CRC=37.2 g/g

AAP (0.7 psi)=14.8 g/g

Vortex (without sieving)=58 s

### Example 3

Example 2 was repeated, except that, in the surface postcrosslinking, rather than 2.0% by weight of aqueous aluminum trilactate solution (22% by weight), 0.5% by weight of aqueous aluminum dihydroxymonoacetate solution (20% by weight), based on polymer, was used.

The superabsorbent had the following properties:

CRC=37.4 g/g

AAP (0.7 psi)=14.2 g/g

Vortex (without sieving)=52 s

### Example 4

Example 2 was repeated, except that, in the surface postcrosslinking, the 2.0% by weight aqueous aluminum trilactate solution (22% by weight) was omitted.

The superabsorbent had the following properties:

CRC=37.8 g/g

AAP (0.7 psi)=13.9 g/g

Vortex (without sieving)=64 s

### Example 5

A mixture of 1000 g of the polymer obtained in example 2 and different amounts of Aeroxide® Alu 130 was coated in a Pflugschar® M5 mixer at room temperature and a shaft speed of 250 revolutions per minute by means of a two-substance spray nozzle with 1.3% by weight, based on the mixture, of a 7.5% by weight aqueous solution of the disodium salt of 2-hydroxy-2-sulfonatoacetic acid (Blancolen® HP, L. Brüggemann KG, Salzstrasse 131, 74076 Heilbronn, Germany). After the spray application, the shaft speed was reduced to 60 revolutions per minute and mixing was continued for another 10 minutes. The resulting product was sieved to obtain the sieve fraction from 150 to 600 μm. The product obtained in each case had the following properties:

| Amount | | | | |
|---|---|---|---|---|
| of Aeroxide ® | CRC | AAP (0.7 psi) | Vortex (unsieved) | Caking 3 h |
| Alu 130 [g] | [g/g] | [g/g] | [s] | [%] |
| 0.5 | 38.1 | 14.3 | 51 | 10 |
| 1.0 | 37.8 | 14.1 | 50 | 1 |
| 1.5 | 38.0 | 14.0 | 48 | 0 |

### Example 6

Example 5 was repeated with the polymer obtained in example 3. The product obtained in each case had the following properties:

| Amount | | | | |
|---|---|---|---|---|
| of Aeroxide ® | CRC | AAP (0.7 psi) | Vortex | Caking 3 h |
| Alu 130 [g] | [g/g] | [g/g] | (unsieved) [s] | [%] |
| 0.5 | 38.3 | 13.7 | 46 | 3 |
| 1.0 | 38.4 | 13.5 | 44 | 1 |
| 1.5 | 38.5 | 13.4 | 43 | 1 |

### Example 7

Example 5 was repeated with the polymer obtained in example 4. The product obtained in each case had the following properties:

| Amount | | | | |
|---|---|---|---|---|
| of Aeroxide ® | CRC | AAP (0.7 psi) | Vortex | Caking 3 h |
| Alu 130 [g] | [g/g] | [g/g] | (unsieved) [s] | [%] |
| 0.5 | 38.5 | 13.4 | 56 | 84 |
| 1.0 | 38.4 | 13.0 | 53 | 45 |
| 1.5 | 38.9 | 12.3 | 54 | 21 |

1. A superabsorbent comprising pyrogenic aluminum oxide.

2. The superabsorbent according to claim 1, which comprises at least 0.01% by weight and at most 6.0% by weight of pyrogenic aluminum oxide.

3. The superabsorbent according to claim 1, wherein the pyrogenic aluminum oxide has a BET surface area of at least 20 and at most 200 m²/g.

4. The superabsorbent according to claim 1, which has been surface postcrosslinked.

5. The superabsorbent according to claim 1, which has been coated with at least one salt of a polyvalent cation.

6. The superabsorbent according to claim 5, which has been coated with an aluminum salt.

7. The superabsorbent according to claim 5, which has been coated with a salt of a polyvalent cation with a hydroxycarboxylic acid.

8. A process for producing a superabsorbent defined in claims 1 by polymerizing a monomer mixture, drying a resulting polymer, and optionally surface postcrosslinking the dried polymer, and optionally coating with a salt of a polyvalent cation, which comprises adding pyrogenic aluminum oxide to the superabsorbent after drying and/or after surface postcrosslinking and optional coating with a salt of a polyvalent cation.

9. The process according to claim 8, which comprises adding pyrogenic aluminum oxide to the superabsorbent after surface postcrosslinking and optional coating with a salt of a polyvalent cation.

10. The process according to claim 8, which comprises polymerizing an aqueous solution of a monomer mixture comprising:
a) at least one ethylenically unsaturated monomer which bears an acid group and is optionally present at least partly in salt form,
b) at least one crosslinker,
c) at least one initiator,
d) optionally one or more ethylenically unsaturated monomer copolymerizable with the monomer mentioned under a), and
e) optionally one or more water-soluble polymer.

11. An article for absorption of fluids, comprising the superabsorbent defined in claims 1.
